(19) United States
(12) Patent Application Publication
(10) Pub. No.: US 2022/0116284 A1
(43) Pub. Date: Apr. 14, 2022

(54) METHODS AND APPARATUS FOR DYNAMIC XPU HARDWARE-AWARE DEEP LEARNING MODEL MANAGEMENT

(71) Applicant: Intel Corporation, Santa Clara, CA (US)

(72) Inventors: Ravishankar Iyer, Portland, OR (US); Nilesh Jain, Portland, OR (US); Juan Munoz, Folsom, CA (US); Eriko Nurvitadhi, Hillsboro, OR (US); Anahita Bhiwandiwalla, San Jose, CA (US); Rajesh Poornachandran, Portland, OR (US)

(21) Appl. No.: 17/645,742

(22) Filed: Dec. 22, 2021

(51) Int. Cl. H04L 41/5003; G06N 3/10

(52) U.S. Cl. CPC H04L 41/5003; G06N 3/10

(57) ABSTRACT

Methods, apparatus, systems, and articles of manufacture for dynamic XPU hardware-aware deep learning model management are disclosed. An example method includes extracting a plurality of models from a dataset, respective ones of the plurality of models optimized for a selected quality of service (QoS) objective of a plurality of QoS objectives, identifying a plurality of feature differences between respective ones of the plurality of models, and identifying a plurality of feature similarities between respective ones of the plurality of models.

### RELATED APPLICATIONS

This application claims priority to U.S. Provisional Patent Application No. 63/222,938, which was filed on Jul. 16, 2021. U.S. Provisional Patent Application No. 63/222,938 is hereby incorporated by reference in its entirety.

### FIELD OF THE DISCLOSURE

This disclosure relates generally to deep learning (DL) model management and, more particularly, to methods and apparatus for dynamic XPU hardware-aware deep learning (DL) model management.

### BACKGROUND

Compute workloads for a computing device may be carried out through use of Deep Learning (DL) models. Deep Learning (DL) models, such as neural networks (NNs), are useful tools that have demonstrated their value solving complex problems regarding pattern recognition, object classification, natural language processing, automatic speech recognition, etc. Identifying an optimal combination of hardware (HW) and/or software (SW) (e.g., a Deep Learning model) to execute a compute workload is complex due to the vast range of available types of hardware and/or Deep Learning (DL) models and customization(s) thereof.

### BRIEF DESCRIPTION OF THE DRAWINGS

FIG. 1 is an illustration of an example automatic machine learning (AutoML) architecture including an example machine-learning system configurator to identify and/or generate a composable machine learning compute node.

FIG. 2 is a block diagram of an example configuration of a dynamic XPU hardware-aware deep learning (DL) model management system 200, implemented in accordance with the teachings of this disclosure.

FIG. 3 is a flowchart representative of example machine readable instructions and/or example operations that may be executed by example processor circuitry to implement the example model training circuitry of FIG. 2.

FIG. 4 is a flowchart representative of example machine readable instructions and/or example operations that may be executed by example processor circuitry to implement the example model management circuitry of FIG. 2.

FIG. 5 is a block diagram of an example processing platform including processor circuitry structured to execute the example machine readable instructions and/or the example operations of FIG. 3 to implement the model training circuitry and model management circuitry of FIG. 2.

FIG. 6 is a block diagram of an example implementation of the processor circuitry of FIG. 4.

FIG. 7 is a block diagram of another example implementation of the processor circuitry of FIG. 4.

FIG. 8 is a block diagram of an example software distribution platform (e.g., one or more servers) to distribute software (e.g., software corresponding to the example machine readable instructions of FIGS. 3-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of a semiconductor device, “above” is not with reference to Earth, but instead is with reference to a bulk region of a base semiconductor substrate (e.g., a semiconductor wafer) on which components of an integrated circuit are formed. Specifically, as used herein, a first component of an integrated circuit is “above” a second component when the first component is farther away from the bulk region of the semiconductor substrate than the second component.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations when processing input data such that other input(s) result in output(s) consistent with the recognized patterns and/or associations.

Many different types of machine learning models and/or machine learning architectures exist. In some examples disclosed herein, a decision tree model is used. Using a decision tree model enables the interpretation of data that is simple and explainable. In general, machine learning models/architectures that are suitable to use in the example approaches disclosed herein will be Convolutional Neural Network (CNN) and/or Deep Neural Network (DNN), wherein interconnections are not visible outside of the model. However, other types of machine learning models could additionally or alternatively be used such as Recurrent Neural Network (RNN), Support Vector Machine (SVM), Gated Recurrent Unit (GRU), Long Short Term Memory (LSTM), etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using known software samples (e.g., malicious and/or clean). However, any other training algorithm may additionally or alternatively be used. In examples disclosed herein, training is performed on a set of models optimized for a selected objective (e.g., performance, accuracy, cost, power, energy, efficiency, etc.).

Training is performed using hyperparameters that control how the learning is performed (e.g., a learning rate, a number of layers to be used in the machine learning model, etc.).

Training is performed using training data. In examples disclosed herein, the training data may be any type of dataset of features (e.g., AI features).

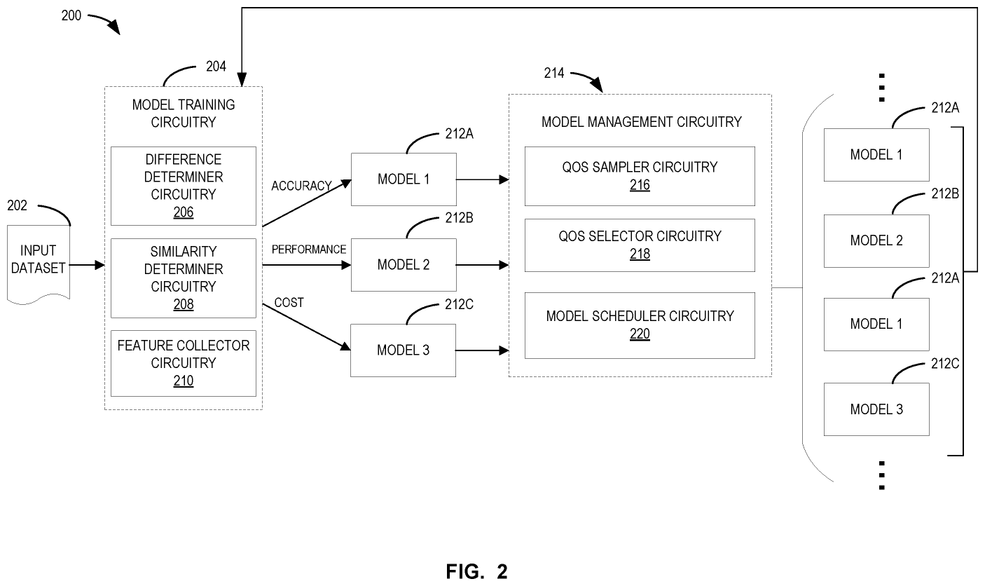

Once training is complete, the model is deployed for use as an executable construct that processes an input and provides an output based on the network of nodes and connections defined in the model. The model is stored in a memory. The model may then be executed by the model management circuitry 208 of FIG. 2.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Exploration and discovery of new Artificial Intelligence (AI) features is a time-consuming problem. The rapid discovery of new hardware features will accelerate the time-to-market for new AI products and/or features.

Currently, training and inference stages in DL model management systems are focused on a single DL model. Some of these single DL models are decomposed into multiple smaller models, however, the focus of these DL model management systems is on single abstract entities. These current DL model management systems do not analyze differences between alternative models to gain insights and to propose new features for AI feature development and/or exploration.

Neural Architecture Search (NAS) refers to approaches for Deep Learning (DL) model management that focus on finding the right network topology for a particular set of requirements. Hardware-aware NAS approaches consider information from the target hardware (HW) when searching for an optimal neural network topology. The primary focus of hardware-aware NAS approaches is to find a single DL model that fits the listed criteria.

Current NAS approaches to DL model management treat each discovered model in isolation. That is, they do not further consider the existence of differences between models (e.g., candidate features optimized for different objectives by the NAS algorithm) to discover new features and/or gain further insights.

Most current NAS solutions fail to consider how, where, and in what conditions the optimized models will be deployed. For instance, the target hardware might have other processes affecting the availability of the device's resources while the model was optimized, creating an assumption that all available resources would be allocated to that model during inference. This proves to be a significant disadvantage during deployment, however, since if the target hardware undergoes a change in resource utilization during runtime, the hardware will most likely require a model replacement to another model that is better suited for the new conditions.

Model duality must be leveraged in order to explore two or more different architectural options optimized for multiple objectives (e.g., accuracy, latency, performance, cost, etc.). A delta between these architectural options is identified and explored to establish new features and/or gaps in the software (SW) or hardware (HW) to aid in model design/management and/or hardware co-optimization.

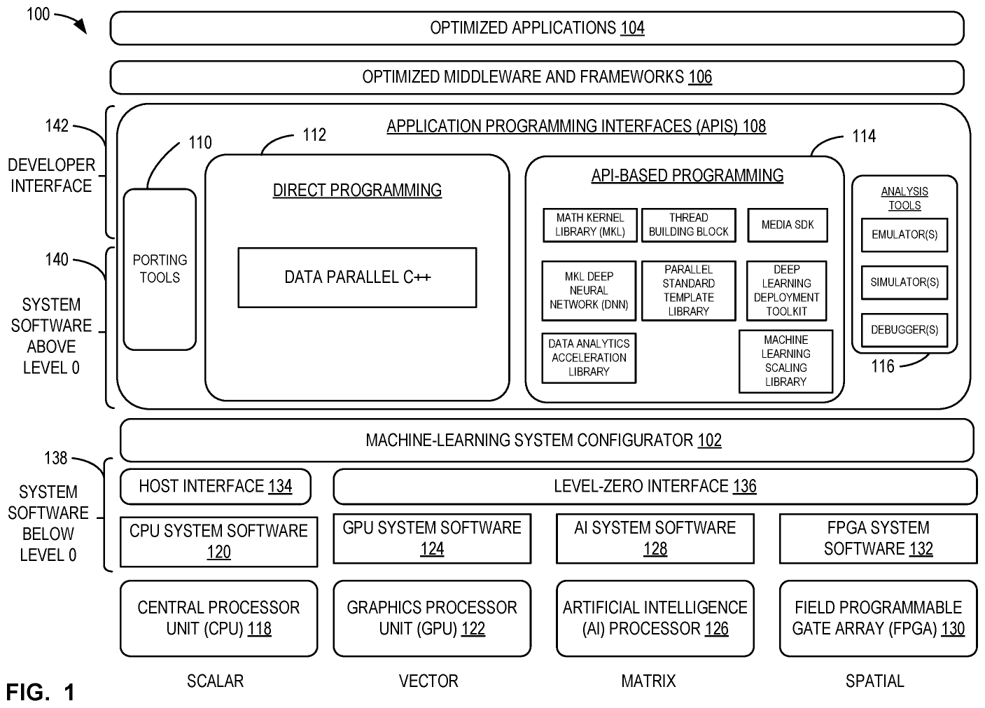

FIG. 1 is an illustration of an example AutoML architecture 100, which includes an example machine-learning (ML) system configurator 102 to identify and/or generate a composable ML compute node. The AutoML architecture 100 includes the ML system configurator 102 to generate a hardware search space and/or a software search space based on a compute task or workload (e.g., an Artificial Intelligence/Machine Learning (AI/ML) compute task or workload). The ML system configurator 102 can identify hardware, or portion(s) thereof, from the hardware search space. The ML system configurator 102 can also discover and/or otherwise identify software (e.g., an AI/ML model), or portion(s) thereof, from the software search space. In some examples, the ML system configurator 102 can individually and/or simultaneously evolve a composable ML compute node by iterating (i) an architecture and/or type of the hardware and/or the software and/or (ii) configuration(s) of the hardware and/or the software. For example, the ML system configurator 102 can evolve the composable ML compute node by evaluating the hardware and/or the software when executing a workload and/or based on a simulation of the hardware and/or software executing the workload. In some such examples, the composable ML compute node can be composable because hardware and/or software components can be selected and assembled in various combinations to satisfy specific or pre-defined requirements (e.g., an accuracy requirement, a latency requirement, a throughput requirement, etc.). In some such examples, in response to an identification of a particular combination of hardware and/or software that satisfies the specific or pre-defined requirements, the ML system configurator 102 can output the combination as a composable ML compute node to execute a workload of interest.

In some examples, a composable ML compute node can be implemented by a single homogeneous computing or electronic system that may be configured and/or otherwise utilized to execute an AI/ML model. For example, the composable ML compute node can be implemented by a single Central Processor Unit (CPU), Graphics Processor Unit (GPU), Artificial Intelligence Processor (AI Processor), Field Programmable Gate Array (FPGA), Digital Signal Processor (DSP), XPU, etc. In some examples, the composable ML compute node can be implemented by portion(s) of a single homogeneous computing or electronic system, such as portion(s) (e.g., kernel(s)) of a single CPU, GPU, AI Processor, FPGA, DSP, XPU, etc. In some such examples, the portion(s) can include a kernel (e.g., a hardware kernel) and/or corresponding interconnect(s) to which different kernel(s), hardware, etc., can be coupled (e.g., physically coupled, communicatively coupled, coupled via a computing or electrical bus, etc.). In some examples, a composable ML compute node can be implemented by multiple ones of the same type of homogeneous computing or electronic system, or portion(s) thereof. For example, the composable ML compute node can be implemented by two or more CPUs (or portion(s) thereof), two or more GPUs (or portion(s) thereof), two or more AI Processors (or portion(s) thereof), two or more FPGAs (or portion(s) thereof), two or more DSPs (or portion(s) thereof), two or more XPUs (or portion(s) thereof), etc.

In some examples, a composable ML compute node can be implemented by a single heterogeneous computing or electronic system that may be configured and/or otherwise utilized to execute an AI/ML model. For example, the composable ML compute node can be implemented by a CPU, a GPU, an AI Processor, an FPGA, a DSP, XPU, etc., and/or any combination(s) thereof. In some such examples, the composable ML compute node can be implemented by one or more CPUs, one or more GPUs, one or more AI Processors, one or more FPGAs, one or more DSPs, one or more XPUs, etc., and/or any combination(s) thereof. In some examples, the composable ML compute node can be implemented by portion(s) of a single heterogeneous computing or electronic system, such as portion(s) of a CPU, GPU, AI Processor, FPGA, DSP, XPU, etc., and/or any combination(s) thereof. In some examples, a composable ML compute node can be implemented by multiple ones of the same heterogeneous computing or electronic system, or portion(s) thereof. For example, the composable ML compute node can be implemented by two or more instances of a heterogeneous computing system, which includes one or more CPUs (or portion(s) thereof), one or more GPUs (or portion(s) thereof), one or more AI Processors (or portion(s) thereof), one or more FPGAs (or portion(s) thereof), one or more DSPs (or portion(s) thereof), one or more XPUs (or portion(s) thereof), etc., and/or combination(s) thereof. In some examples, the composable ML compute node can be implemented by two or more different heterogeneous computing or electronic systems. For example, the composable ML compute node can be implemented by a first heterogeneous computing system and a second heterogeneous computing system. In some such examples, portion(s) of the first heterogeneous computing system and the second heterogeneous computing system can be different.

In some examples, the composable ML compute node can include, store, and/or otherwise access an executable construct to execute an AI/ML model to complete a workload, or portion(s) thereof. For example, the executable construct can be implemented by a configuration image, an executable binary, executable code (e.g., executable machine-readable code), an executable file (e.g., an executable binary file), an executable program, executable instructions (e.g., executable machine-readable instructions), etc., that, when executed, can implement an AI/ML model to effectuate completion of AI/ML workloads.

The AutoML architecture 100 of the illustrated example includes example optimized applications 104, example optimized middleware and frameworks 106, and example application programming interfaces (APIs) 108. In some examples, the optimized applications 104 can be implemented by applications (e.g., software applications, web- or browser-based applications, etc.) that are customized, tailored, and/or otherwise optimized to effectuate the identification and/or generation of a composable ML compute node. For example, the optimized applications 104 can be accessed, utilized, etc., by a developer (e.g., a software developer, a researcher, etc.), Information Technology (IT) personnel, etc. In some such examples, the optimized applications 104 can be accessed, utilized, etc., to co-design a hardware/software (HW/SW) solution for a technical problem that can benefit from AI/ML techniques. In some examples, the optimized middleware and frameworks 106 can be implemented by middleware and frameworks that are customized, tailored, and/or otherwise optimized to effectuate the identification and/or generation of a composable ML compute node. For example, the optimized middleware and frameworks 106 can implement an interface (e.g., communication, connectivity, etc.) between the optimized applications 104 and the APIs 108.

The APIs 108 of the illustrated example can be invoked to program, develop, and/or otherwise generate an AI/ML application by at least one of direct programming or API-based programming. The APIs 108 of the illustrated example include example porting tools 110, example direct programming APIs 112, example API-based programming APIs 114, and example analysis tools 116.

In some examples, the porting tools 110 can be implemented by software (e.g., a software application) that can adapt a program for the purpose of achieving some form of execution in a first computing or electronic environment that is different from a second computing or electronic environment for which the program was originally designed. For example, the porting tools 110 can convert and/or otherwise adapt a first program developed for a first type of hardware, operating system (OS), library, etc., into a second program for a second type of hardware, OS, library, etc.

In some examples, the direct programming APIs 112 can be invoked to effectuate direct programming tasks, which may include developing and/or compiling data parallel C++ applications. In some examples, the API-based programming APIs 114 can be invoked to effectuate API-based programming, which may include developing and/or compiling applications that call (or invoke, instantiate, etc.) a Math Kernel Library (MKL), an MKL Deep Neural Network (DNN) library, a data analytics acceleration library, a thread building block library, a parallel standard template library, a media software development kit (SDK), a deep learning deployment toolkit, a machine learning scaling library, etc., and/or any combination(s) thereof.

In some examples, the analysis tools 116 can be called, instantiated, and/or otherwise invoked to analyze hardware, software, and/or configuration(s) thereof of a composable ML compute node. For example, the analysis tools 116 can instantiate emulator(s) to emulate all of the hardware and/or software features of the composable ML compute node to generate and/or otherwise output one or more evaluation parameters. In some such examples, the evaluation parameters can include parameters representative and/or otherwise indicative of accuracy, latency, a number of cycles to complete a workload, or throughput of the composable ML compute node. In some examples, the evaluation parameters can include parameters representative and/or otherwise indicative of a processor or clock frequency, a fabric frequency, a read memory bandwidth, a write memory bandwidth, hardware de-rate factors, a number of memory ports, a number of data processing units (DPUs), a number of model layers (e.g., neural network layers, convolution layers, etc.) an activation precision (e.g., a precision of activation values to be processed), a weight precision (e.g., a precision of weight values to be processed), etc., and/or any combination(s) thereof. For example, the analysis tools 116 can execute an emulator based on the composable ML compute node. In some such examples, the analysis tools 116 can execute the emulator to determine a throughput of the composable ML compute node when the composable ML compute node executes a particular AI/ML model having a particular configuration.

In some examples, the analysis tools 116 can instantiate simulator(s) to simulate the behavior, the configuration, etc., of a composable ML compute node to generate and/or otherwise output one or more evaluation parameters. For example, the analysis tools 116 can execute a model (e.g., a simulation model, an AI/ML model, etc.) based on the composable ML compute node. In some such examples, the analysis tools 116 can execute the model to estimate, predict, and/or otherwise determine a throughput of the composable ML compute node when the composable ML compute node executes a particular AI/ML model having a particular configuration.

The AutoML architecture 100 of the illustrated example includes different types of hardware and/or software from which a composable ML compute node can be generated. In the illustrated example, the AutoML architecture 100 includes interfaces and target system software for scalar, vector, matrix, and spatial hardware. Additionally and/or alternatively, any other type of hardware may be used. In this example, the scalar hardware is implemented by an example CPU 118 and example CPU system software 120. For example, the CPU system software 120 can include instructions corresponding to a CPU Instruction Set Architecture (ISA). In this example, the vector hardware is implemented by an example GPU 122 and example GPU system software 124. For example, the GPU system software 124 can include kernels, portion(s) of code, etc., such as kernels, compute kernels, and/or shaders. In some examples, the kernels, the portion(s) of code), etc., can be represented in a high-level programming language such as, for example, a High-Level Shader Language (HLSL), OpenCL, etc.

In this example, the matrix hardware is implemented by an example AI processor 126 and example AI system software 128. For example, the AI system software 128 can include one or more AI/ML algorithms, models, etc., such as neural networks (e.g., convolution neural networks (CNNs), deep neural networks (DNNs), recurrent neural networks (RNNs), etc.), Linear Regression models, Logistic Regression Models, Decision Tree Models, Learning Vector Quantization Models, etc., and/or combination(s) thereof. In this example, the spatial hardware is implemented by an example FPGA 130 and example FPGA system software 132. For example, the FPGA system software 132 can include kernels, portion(s) of code, etc., based on a hardware description language (HDL) such as Verilog.

The ML system configurator 102 of the illustrated example can interface with the CPU 118 and/or the CPU system software 120 via an example host interface 134. The ML system configurator 102 of the illustrated example can interface with the GPU 122, the GPU system software 124, the AI processor 126, the AI system software 128, the FPGA 130, and/or the FPGA system software 132 via an example level-zero interface 136.

In the illustrated example, the CPU system software 120, the GPU system software 124, the AI system software 128, the FPGA system software 132, the host interface 134, and/or the level-zero interface 136 can correspond to and/or otherwise implement example system software below level zero 138. For example, system software below level zero 138 can correspond to and/or otherwise implement low-level direct-to-metal interfaces that are tailored to hardware, such as the CPU 118, the GPU 122, etc.

In the illustrated example, the APIs 108 can implement example system software above level zero 140 and an example developer interface 142. For example, a developer, a user, etc., can access and/or otherwise utilize the AutoML architecture 100 by way of the APIs 108. In some examples, a developer, a user, etc., can access and/or otherwise utilize system software at a higher level than low-level direct-to-metal interfaces by way of the APIs 108. In some examples, a developer, a user, etc., can access and/or otherwise utilize the system software below level zero 138 via the host interface 134 and/or the level-zero interface 136.

FIG. 2 is a block diagram of an example configuration of a dynamic XPU hardware-aware deep learning (DL) model management system implemented in accordance with the teachings of this disclosure. The example DL model management system 200 includes an example input dataset 202, example model training circuitry 204, including example difference determiner circuitry 206, example similarity determiner circuitry 208, and example feature collector circuitry 210, an example first, second, and third model 212A, 212B, and 212C, and example model management circuitry 214, including example QoS selector circuitry 216, example QoS sampler circuitry 218, and example model scheduler circuitry 220.

In examples disclosed herein, the example input dataset 202 may contain candidate features, objectives with which models are to be optimized, etc. The example input dataset 202 is transmit to the model training circuitry 204 for use in the training and/or optimization of models by the DL model management system 200.

The example model training circuitry 204, including the example difference determiner circuitry 206, the example similarity determiner circuitry 208, and the example feature collector circuitry 210, receives the example input dataset 202 and generates a set of models (e.g., first model 212A, second model 212B, and third model 212C) based on a chosen objective. For example, in the DL model management system 200 disclosed herein, the first model, 212A, is trained to optimize accuracy as the key objective, the second model, 212B, is trained to optimize performance as the key objective, and the third model, 212C, is trained to optimize cost as the key objective.

The example difference determiner circuitry 206 analyzes the feature lists of models optimized for different selected objectives (e.g., accuracy, performance, cost, etc.) to identify feature differences between the various models. In examples disclosed herein, the difference determiner circuitry 206 identifies these differences by associating features that are present when a first objective was selected for a first model (e.g., features from the first model 212A with a selected objective of accuracy) but are not present when a second objective was selected for a second model (e.g., features from the second model 212B with a selected objective of performance). In determining these differences, further insight is gained into why a model might have improved its overall performance at the cost of another objective (e.g., cost).

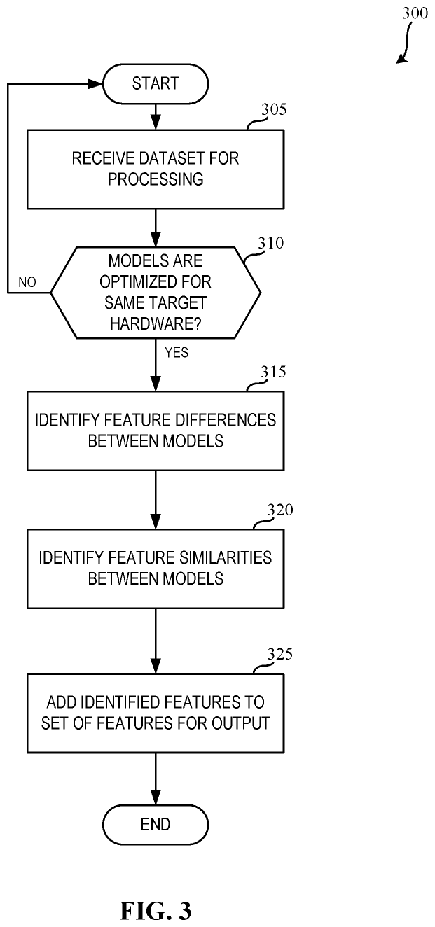

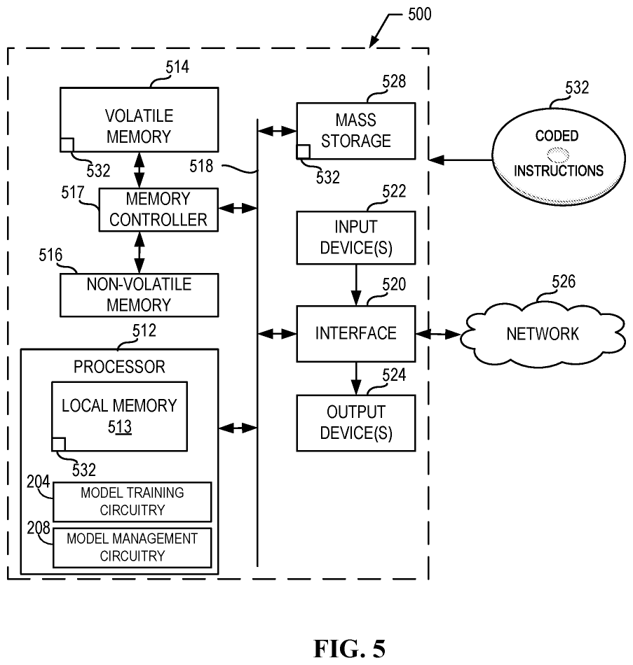

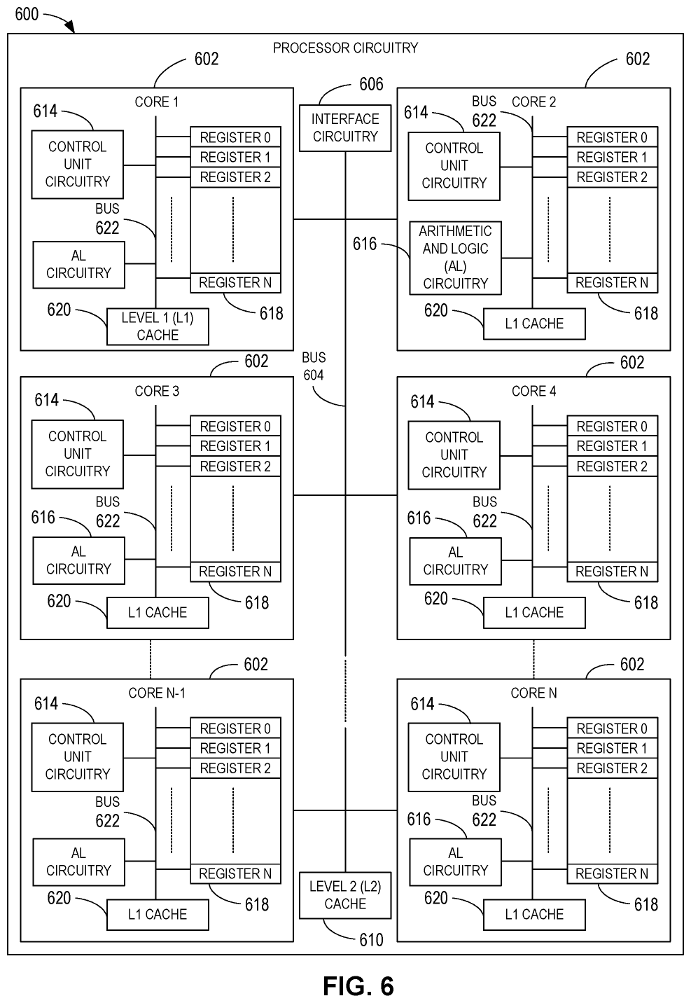

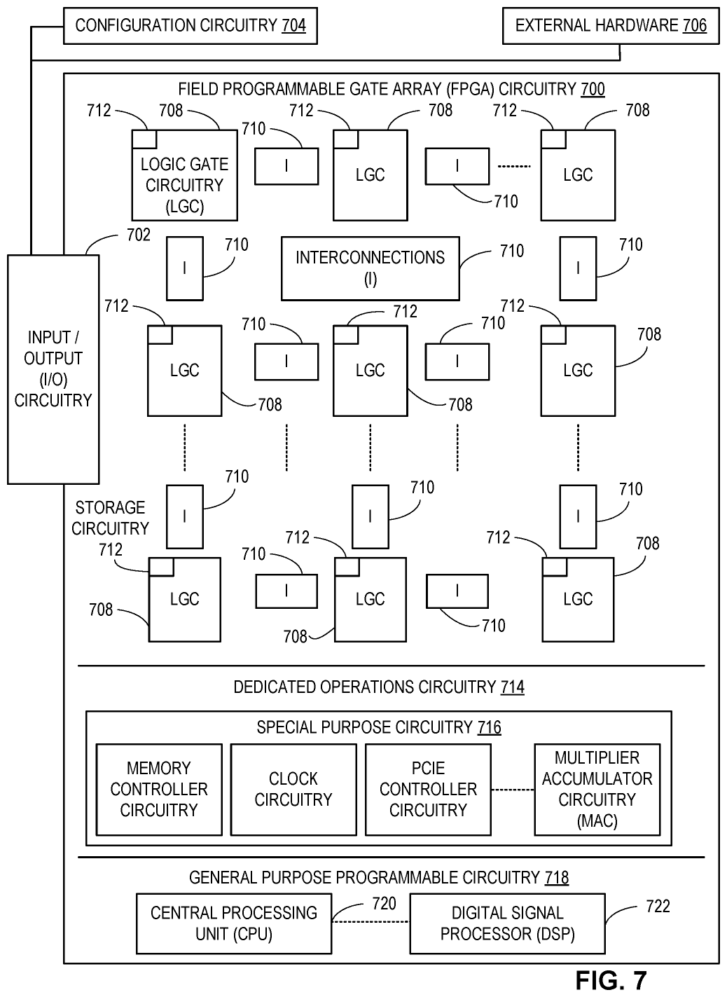

In some examples, the model training circuitry 204 includes means for identifying candidate differences between models optimized for different selected objectives (e.g., accuracy, performance, cost, etc.). For example, the means for identifying differences may be implemented by the example difference determiner circuitry 206. In some examples, the example difference determiner circuitry 206 may be instantiated by processor circuitry such as the example processor circuitry 512 of FIG. 5. For instance, the example difference determiner circuitry 206 may be instantiated by the example general purpose processor circuitry 600 of FIG. 6 executing machine executable instructions such as that implemented by at least blocks 305, 310, and 315 of FIG. 3. In some examples, the example difference determiner circuitry 206 may be instantiated by hardware logic circuitry, which may be implemented by an ASIC or the FPGA circuitry 700 of FIG. 7 structured to perform operations corresponding to the machine readable instructions. Additionally or alternatively, the the example difference determiner circuitry 206 may be instantiated by any other combination of hardware, software, and/or firmware. For example, the example difference determiner circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example similarity determiner circuitry 208 analyzes the feature lists of models optimized for different selected objectives (e.g., accuracy, performance, cost, etc.) to identify feature similarities between the various models. In examples disclosed herein, the similarity determiner circuitry 208 identifies these similarities by associating features that are present when a first objective was selected for a first model (e.g., features from the first model 212A with a selected objective of accuracy) and are still present when a second objective was selected for a second model (e.g., features from the second model 212B with a selected objective of performance). In determining these similarities, further insight is gained into which features are important for overall model performance (e.g., it can be concluded that some layers are very important when performing object detection).

In some examples, the model training circuitry 204 includes means for identifying similarities between models optimized for different selected objectives (e.g., accuracy, performance, cost, etc.). For example, the means for identifying similarities may be implemented by the example similarity determiner circuitry 208. In some examples, the example similarity determiner circuitry 208 may be instantiated by processor circuitry such as the example processor circuitry 512 of FIG. 5. For instance, the example similarity determiner circuitry 208 may be instantiated by the example general purpose processor circuitry 600 of FIG. 6 executing machine executable instructions such as that implemented by at least block 320 of FIG. 3. In some examples, the example similarity determiner circuitry 208 may be instantiated by hardware logic circuitry, which may be implemented by an ASIC or the FPGA circuitry 700 of FIG. 7 structured to perform operations corresponding to the machine readable instructions. Additionally or alternatively, the example similarity determiner circuitry 208 may be instantiated by any other combination of hardware, software, and/or firmware. For example, the example similarity determiner circuitry 208 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example feature collector circuitry 210 collects the list of features identified by both the difference determiner circuitry 206 and the similarity determiner circuitry 120. In some examples, the feature collector circuitry 210 may then perform further analysis on the list of collected features, however in examples disclosed herein, the list may be retained for output.

In some examples, the model training circuitry 204 includes means for collecting features identified by the example difference determiner circuitry 206 and the example similarity determiner circuitry 208. For example, the means for collecting features may be implemented by the example feature collector circuitry 210. In some examples, the example feature collector circuitry 210 may be instantiated by processor circuitry such as the example processor circuitry 512 of FIG. 5. For instance, the example feature collector circuitry 210 may be instantiated by the example general purpose processor circuitry 600 of FIG. 6 executing machine executable instructions such as that implemented by at least block 325 of FIG. 3. In some examples, the example feature collector circuitry 210 may be instantiated by hardware logic circuitry, which may be implemented by an ASIC or the FPGA circuitry 700 of FIG. 7 structured to perform operations corresponding to the machine readable instructions. Additionally or alternatively, the example feature collector circuitry 210 may be instantiated by any other combination of hardware, software, and/or firmware. For example, the example feature collector circuitry 210 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The first, second, and third models (212A, 212B, and 212C) obtained from the input dataset 202 are input into the example model management circuitry 214 for further processing after use by the model training circuitry 204. In examples disclosed herein, the first model 212A is optimized to maximize the selected objective of accuracy, the second model 212B is optimized to maximize the selected objective of performance, and the third model 212C is optimized to maximize the selected objective of cost.

In examples disclosed herein, the example model management circuitry 214 includes example Quality of Service (QoS) sampling circuitry 216, example QoS selector circuitry 218, and example model scheduler circuitry 220.

The example Quality of Service (QoS) sampler circuitry 216 samples a current state of the target hardware platform. For example, the Quality of Service (QoS) sampler circuitry 216 may determine that the target hardware platform is currently responding to a high priority request from an application.

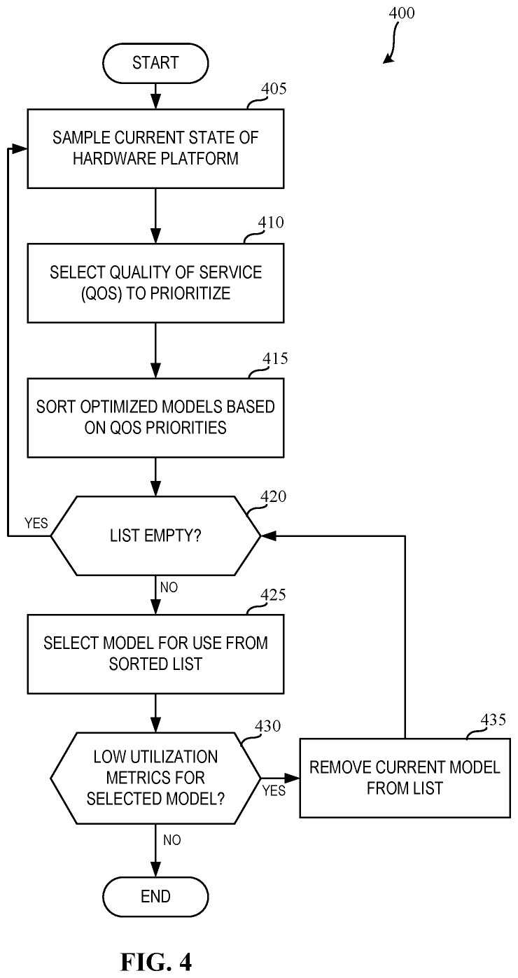

In some examples, the model management circuitry 214 includes means for determining a current state of a target hardware platform. For example, the means for determining may be implemented by the example QoS sampler circuitry 216. In some examples, the example QoS sampler circuitry 216 may be instantiated by processor circuitry such as the example processor circuitry 512 of FIG. 5. For instance, the example QoS sampler circuitry 216 may be instantiated by the example general purpose processor circuitry 600 of FIG. 6 executing machine executable instructions such as that implemented by at least block 405 of FIG. 4. In some examples, the example QoS sampler circuitry 216 may be instantiated by hardware logic circuitry, which may be implemented by an ASIC or the FPGA circuitry 700 of FIG. 7 structured to perform operations corresponding to the machine readable instructions. Additionally or alternatively, the example QoS sampler circuitry 216 may be instantiated by any other combination of hardware, software, and/or firmware. For example, the example QoS sampler circuitry 216 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example QoS selector circuitry 218 selects a quality of service (QoS) to be prioritized based on the current state of the target hardware platform, as determined by the QoS sampler circuitry 216. For example, the QoS selector circuitry 218 may choose accuracy as the QoS objective of top priority if the QoS sampler circuitry 216 establishes prior that the target hardware platform is currently responding to a high priority request from an application.

In some examples, the model management circuitry 214 includes means for selecting a quality of service (QoS) objective. For example, the means for selecting a QoS objective may be implemented by the example QoS selector circuitry 218. In some examples, the example QoS selector circuitry 218 may be instantiated by processor circuitry such as the example processor circuitry 512 of FIG. 5. For instance, the example QoS selector circuitry 218 may be instantiated by the example general purpose processor circuitry 600 of FIG. 6 executing machine executable instructions such as that implemented by at least blocks 410, 415, and 420 of FIG. 4. In some examples, the the example QoS selector circuitry 218 may be instantiated by hardware logic circuitry, which may be implemented by an ASIC or the FPGA circuitry 700 of FIG. 7 structured to perform operations corresponding to the machine readable instructions. Additionally or alternatively, the example QoS selector circuitry 218 may be instantiated by any other combination of hardware, software, and/or firmware. For example, the example QoS selector circuitry 218 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example model scheduler circuitry 220 selects the model that will best satisfy the requirements of the selected quality of service (QoS) objective for prioritization, for use by the target hardware platform. Additionally, the model scheduler circuitry 220 also monitors utilization metrics of the target hardware platform. If any of the utilization metrics is established to be lower than a pre-determined threshold value, the model scheduler circuitry 220 then adjusts the model selection to produce another model for use by the target hardware platform. For example, if the first model 212A begins to produce low utilization metrics on the hardware platform, the model scheduler circuitry 220 selects the second model 212B as the new model for use. If the second model 212B begins to yield low utilization metrics after some time, the model scheduler circuitry 220 may determine that the first model 212A is better for use by the hardware platform. In examples disclosed herein, the model scheduler circuitry 220 includes a feedback loop wherein the progression of selected models is used as input to the example model training circuitry 204.

In some examples, the model management circuitry 214 includes means for selecting a model. For example, the means for selecting may be implemented by the example model scheduler circuitry 220. In some examples, the example model scheduler circuitry 220 may be instantiated by processor circuitry such as the example processor circuitry 512 of FIG. 5. For instance, the example model scheduler circuitry 220 may be instantiated by the example general purpose processor circuitry 600 of FIG. 6 executing machine executable instructions such as that implemented by at least blocks 425, 430, and 435 of FIG. 4. In some examples, the example model scheduler circuitry 220 may be instantiated by hardware logic circuitry, which may be implemented by an ASIC or the FPGA circuitry 700 of FIG. 7 structured to perform operations corresponding to the machine readable instructions. Additionally or alternatively, the example model scheduler circuitry 220 may be instantiated by any other combination of hardware, software, and/or firmware. For example, the example model scheduler circuitry 220 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the model training circuitry 204 of FIG. 2 is illustrated in FIG. 2, one or more of the elements, processes, and/or devices illustrated in FIG. 2 may be combined, divided, re-arranged, omitted, eliminated, and/or implemented in any other way. Further, the example difference determiner circuitry 206, the example similarity determiner circuitry 208, the example feature collector circuitry 210, and/or, more generally, the example model training circuitry 204 of FIG. 2, may be implemented by hardware alone or by hardware in combination with software and/or firmware. Thus, for example, any of the example difference determiner circuitry 206, the example similarity determiner circuitry 208, the example feature collector circuitry 210, and/or, more generally, the example model training circuitry 204, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example model training circuitry 204 of FIG. 2 may include one or more elements, processes, and/or devices in addition to, or instead of, those illustrated in FIG. 2, and/or may include more than one of any or all of the illustrated elements, processes and devices.

While an example manner of implementing the model management circuitry 214 of FIG. 2 is illustrated in FIG. 2, one or more of the elements, processes, and/or devices illustrated in FIG. 2 may be combined, divided, re-arranged, omitted, eliminated, and/or implemented in any other way. Further, the example Quality of Service (QoS) sampler circuitry 216, the example QoS selector circuitry 218, the example model scheduler circuitry 220, and/or, more generally, the example model management circuitry 214 of FIG. 2, may be implemented by hardware alone or by hardware in combination with software and/or firmware. Thus, for example, any of the example Quality of Service (QoS) sampler circuitry 216, the example QoS selector circuitry 218, the example model scheduler circuitry 220, and/or, more generally, the example model management circuitry 214, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example model management circuitry 214 of FIG. 2 may include one or more elements, processes, and/or devices in addition to, or instead of, those illustrated in FIG. 2, and/or may include more than one of any or all of the illustrated elements, processes and devices.

A flowchart representative of example hardware logic circuitry, machine readable instructions, hardware implemented state machines, and/or any combination thereof for implementing the model training circuitry 204 of FIG. 2 is shown in FIG. 3. A flowchart representative of example hardware logic circuitry, machine readable instructions, hardware implemented state machines, and/or any combination thereof for implementing the model management circuitry 214 of FIG. 2 is shown in FIG. 4. The machine readable instructions may be one or more executable programs or portion(s) of an executable program for execution by processor circuitry, such as the processor circuitry 512 shown in the example processor platform 500 discussed below in connection with FIG. 5 and/or the example processor circuitry discussed below in connection with FIGS. 6 and/or 7. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 3 and/or 4, many other methods of implementing the example model training circuitry 204 and/or the example model management circuitry 214 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3 and/or 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to identify and collect similar and/or different features between the collection of models optimized for various target platform objectives. The machine readable instructions and/or the operations 300 of FIG. 3 begin at block 305, at which the difference determiner circuitry 206 receives the input dataset 202 of FIG. 2 for processing.

As illustrated in FIG. 3, at block 305, the difference determiner circuitry 206 receives a dataset (e.g., input dataset 202 from FIG. 2) for processing. In examples disclosed herein, the dataset includes optimized models, however, in other examples, the dataset may be configured to include candidate features, platform metrics, etc.

At block 310, the difference determiner circuitry 206 checks whether the models contained within the example dataset received in block 305 (e.g., input dataset 202 from FIG. 2) are optimized for the same target hardware. Before the variety of models are to be compared against one another, the difference determiner circuitry 206 is to check for target hardware matches for the models. If the difference determiner circuitry 206 establishes that the models are optimized for the same target hardware, the process moves forward to block 315. However, if the difference determiner circuitry 206 determines that the models are not all optimized for the same target hardware, the process moves back to the start.

At block 315, the difference determiner circuitry 206 identifies feature differences between each of the models received for processing in block 305. In examples disclosed herein, the example dataset received for processing in block 305 includes a variety of models, each model optimized for a different objective on the same target hardware platform. Accordingly, the difference determining circuity 206 identifies feature differences between each of the models by comparing lists of features present in each of the models and selecting those which are not present in all models. For example, certain features that are present for a model with a selected objective of accuracy but are not present for a model with a selected objective of performance are identified by the difference determiner circuitry 206.

At block 320, the example similarity determiner circuitry 208 performs a similar process as the example difference determiner circuitry 206, however, feature similarities between each of the models are identified. For example, certain features that are present for a model with a selected objective of accuracy and are also present for a model with a selected objective of performance are identified by the similarity determiner circuitry 208.

At block 325, the example feature collector circuitry 210 aggregates the features identified by the example difference determiner circuitry 206 and the example similarity determiner circuitry 208 into a single set. In example disclosed herein, the feature collector circuitry 210 may output the aggregated feature set.

FIG. 4 is a flowchart representative of example machine readable instructions and/or example operations 400 that may be executed and/or instantiated by processor circuitry to dynamically select and/or adjust an optimized model for use based on a current state and/or model utilization metrics of the target hardware platform. The machine readable instructions and/or the operations 400 of FIG. 4 begin at block 402, at which the Quality of Service (QoS) sampler circuitry 216 samples the current state of the hardware platform.

As illustrated in FIG. 4, at block 405, the QoS sampler circuitry 216 samples the current state of the hardware platform. For example, the QoS sampler circuitry 216 may determine that the hardware platform is currently responding to a high priority request from an application.

At block 410, the QoS selector circuitry 218 chooses a quality of service (QoS) objective (e.g., cost, accuracy, performance, etc.) to prioritize based on the current state of the hardware platform determined in block 405 (e.g., currently responding to a high priority request from an application) by the QoS sampler circuitry 216. For example, the QoS selector circuitry 218 may choose accuracy as the QoS objective of top priority if the QoS sampler circuitry 216 establishes that the hardware platform is currently responding to a high priority request from an application.

At block 415, the QoS selector circuitry 218 sorts the collection of models, each optimized for a different QoS objective, based on the selected QoS priority objective in block 410. In examples disclosed herein, the QoS selector circuitry 218 may sort the collection of models in descending order, based on ability to maximize the selected QoS objective for prioritization.

At block 420, the QoS selector circuitry 218 checks to see if the list of sorted models (e.g., sorted based on ability to maximize the selected QoS objective for prioritization) is empty. If the QoS selector circuitry 218 determines that the list is empty, the process moves back to block 405. However, if the QoS selector circuitry 218 determines that the list is not empty, the process moves forward to block 425.

At block 425, the model scheduler circuitry 220 selects the model that will satisfy the requirements of the selected QoS objective for prioritization, for use by the target hardware platform. In examples disclosed herein, since the list of optimized models is sorted in descending order based on ability to satisfy the selected QoS priority objective, the first model in the list is selected for use.

At block 430, the model scheduler circuitry 220 determines whether the selected model is yielding low utilization metrics on the target hardware platform. If the model scheduler circuitry 220 determines that the model does indeed have low utilization metrics, the process moves to block 435. However, if the model scheduler circuitry 220 determines that the selected model is not yielding low utilization metrics on the target platform, the process is ended.

At block 435, the model scheduler circuitry 220, after determining that the selected model is yielding low utilization metrics on the target hardware platform, removes the model in current use from the list of sorted models. Then, the process moves back to block 420 where the QoS selector circuitry 218 checks to see if the list of sorted models is empty.

FIG. 5 is a block diagram of an example processor platform 500 structured to execute and/or instantiate the machine readable instructions and/or the operations of FIGS. 3-4 to implement the model training circuitry 204, model management circuitry 214, and/or more generally, the Deep Learning (DL) model management system 200 of FIG. 2. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 600 of the illustrated example includes processor circuitry 612. The processor circuitry 512 of the illustrated example is hardware. For example, the processor circuitry 512 can be implemented by one or more integrated circuits, logic circuits, FPGAs, microprocessors, CPUs, GPUs, DSPs, and/or microcontrollers from any desired family or manufacturer. The processor circuitry 512 may be implemented by one or more semiconductor based (e.g., silicon based) devices. In this example, the processor circuitry 512 implements the example model training circuitry 204, including the example difference determiner circuitry 206, the example similarity determiner circuitry 208, and the example feature collector circuitry 210 and the example model management circuitry 214, including the example quality of service (QoS) sampler circuitry 216, the example QoS selector circuitry 218, and the example model scheduler circuitry.

The processor circuitry 512 of the illustrated example includes a local memory 513 (e.g., a cache, registers, etc.). The processor circuitry 512 of the illustrated example is in communication with a main memory including a volatile memory 514 and a non-volatile memory 516 by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517.

The processor platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user to enter data and/or commands into the processor circuitry 512. The input device(s) 522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 500 of the illustrated example also includes one or more mass storage devices 528 to store software and/or data. Examples of such mass storage devices 528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 532, which may be implemented by the machine readable instructions of FIGS. 3-4, may be stored in the mass storage device 528, in the volatile memory 514, in the non-volatile memory 516, and/or on a removable non-transitory computer readable storage medium such as a CD or DVD.

FIG. 6 is a block diagram of an example implementation of the processor circuitry 512 of FIG. 5. In this example, the processor circuitry 512 of FIG. 5 is implemented by a general purpose microprocessor 600. The general purpose microprocessor circuitry 600 executes some or all of the machine readable instructions of the flowcharts of FIGS. 3-4 to effectively instantiate the model training circuitry 204 and the model management circuitry 214 of FIG. 2 as logic circuits to perform the operations corresponding to those machine readable instructions. in some such examples, the circuitry of FIG. 2 is instantiated by the hardware circuits of the microprocessor 600 in combination with the instructions. For example, the microprocessor 600 may implement multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIGS. 3-4.

The cores 602 may communicate by a first example bus 604. In some examples, the first bus 604 may implement a communication bus to effectuate communication associated with one(s) of the cores 602. For example, the first bus 604 may implement at least one of an Inter-Integrated Circuit (I2C) bus, a Serial Peripheral Interface (SPI) bus, a PCI bus, or a PCIe bus. Additionally or alternatively, the first bus 604 may implement any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2_cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the L1 cache 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating point operations. In yet other examples, the AL circuitry 616 may include first AL circuitry that performs integer based operations and second AL circuitry that performs floating point operations. In some examples, the AL circuitry 616 may be referred to as an Arithmetic Logic Unit (ALU). The registers 618 are semiconductor-based structures to store data and/or instructions such as results of one or more of the operations performed by the AL circuitry 616 of the corresponding core 602. For example, the registers 618 may include vector register(s), SIMD register(s), general purpose register(s), flag register(s), segment register(s), machine specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure including distributed throughout the core 602 to shorten access time. The second bus 622 may implement at least one of an I2C bus, a SPI bus, a PCI bus, or a PCIe bus

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 7 is a block diagram of another example implementation of the processor circuitry 512 of FIG. 5. In this example, the processor circuitry 512 is implemented by FPGA circuitry 700. The FPGA circuitry 700 can be used, for example, to perform operations that could otherwise be performed by the example microprocessor 600 of FIG. 6 executing corresponding machine readable instructions. However, once configured, the FPGA circuitry 600 instantiates the machine readable instructions in hardware and, thus, can often execute the operations faster than they could be performed by a general purpose microprocessor executing the corresponding software.

More specifically, in contrast to the microprocessor 600 of FIG. 6 described above (which is a general purpose device that may be programmed to execute some or all of the machine readable instructions represented by the flowcharts of FIGS. 3-4 but whose interconnections and logic circuitry are fixed once fabricated), the FPGA circuitry 700 of the example of FIG. 7 includes interconnections and logic circuitry that may be configured and/or interconnected in different ways after fabrication to instantiate, for example, some or all of the machine readable instructions represented by the flowcharts of FIGS. 3-4. In particular, the FPGA 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the software represented by the flowcharts of FIGS. 3-4. As such, the FPGA circuitry 700 may be structured to effectively instantiate some or all of the machine readable instructions of the flowcharts of FIGS. 3-4 as dedicated logic circuits to perform the operations corresponding to those software instructions in a dedicated manner analogous to an ASIC. Therefore, the FPGA circuitry 700 may perform the operations corresponding to the some or all of the machine readable instructions of FIGS. 3-4 faster than the general purpose microprocessor can execute the same.

In the example of FIG. 7, the FPGA circuitry 700 is structured to be programmed (and/or reprogrammed one or more times) by an end user by a hardware description language (HDL) such as Verilog. The FPGA circuitry 700 of FIG. 7, includes example input/output (I/O) circuitry 702 to obtain and/or output data to/from example configuration circuitry 704 and/or external hardware (e.g., external hardware circuitry) 706. For example, the configuration circuitry 704 may implement interface circuitry that may obtain machine readable instructions to configure the FPGA circuitry 700, or portion(s) thereof. In some such examples, the configuration circuitry 704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 706 may implement the microprocessor 700 of FIG. 7. The FPGA circuitry 700 also includes an array of example logic gate circuitry 708, a plurality of example configurable interconnections 710, and example storage circuitry 712. The logic gate circuitry 708 and interconnections 710 are configurable to instantiate one or more operations that may correspond to at least some of the machine readable instructions of FIGS. 3-4 and/or other desired operations. The logic gate circuitry 708 shown in FIG. 7 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations. The logic gate circuitry 708 may include other electrical structures such as look-up tables (LUTs), registers (e.g., flip-flops or latches), multiplexers, etc.

The interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example Dedicated Operations Circuitry 714. In this example, the Dedicated Operations Circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the processor circuitry 512 of FIG. 5, many other approaches are contemplated. For example, as mentioned above, modern FPGA circuitry may include an on-board CPU, such as one or more of the example CPU 720 of FIG. 7. Therefore, the processor circuitry 512 of FIG. 5 may additionally be implemented by combining the example microprocessor 600 of FIG. 6 and the example FPGA circuitry 700 of FIG. 7. In some such hybrid examples, a first portion of the machine readable instructions represented by the flowcharts of FIGS. 3-4 may be executed by one or more of the cores 602 of FIG. 6, a second portion of the machine readable instructions represented by the flowcharts of FIGS. 3-4 may be executed by the FPGA circuitry 700 of FIG. 7, and/or a third portion of the machine readable instructions represented by the flowcharts of FIGS. 3-4 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 512 of FIG. 5 may be in one or more packages. For example, the processor circuitry 600 of FIG. 65 and/or the FPGA circuitry 700 of FIG. 7 may be in one or more packages. In some examples, an XPU may be implemented by the processor circuitry 512 of FIG. 5, which may be in one or more packages. For example, the XPU may include a CPU in one package, a DSP in another package, a GPU in yet another package, and an FPGA in still yet another package.

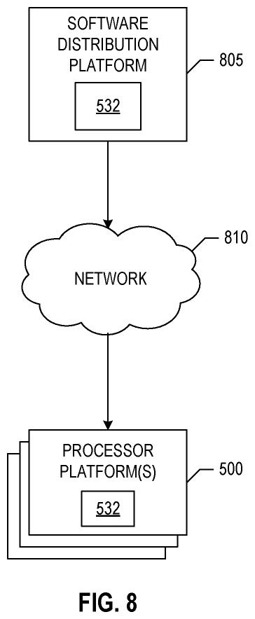

A block diagram illustrating an example software distribution platform 805 to distribute software such as the example machine readable instructions 532 of FIG. 5 to hardware devices owned and/or operated by third parties is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions 300, 400 of FIGS. 3-4, as described above. The one or more servers of the example software distribution platform 805 are in communication with a network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions 300, 400 of FIGS. 3-4, may be downloaded to the example processor platform 500, which is to execute the machine readable instructions 532 to implement the deep learning (DL) model management system 200. In some example, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices.

From the foregoing, it will be appreciated that example systems, methods, apparatus, and articles of manufacture have been disclosed for dynamic XPU hardware-aware deep learning (DL) model management. Disclosed systems, methods, apparatus, and articles of manufacture improve the efficiency of using a computing device by allowing for the rapid discovery of new hardware features, which accelerates the time-to-market for new Artificial Intelligence (AI) products and/or features and enhances performance improvement measures for computing devices through application of the newly-discovered features. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to for dynamic XPU hardware-aware deep learning (DL) model management are disclosed herein. Further examples and combinations thereof include the following:

Example 1 includes an apparatus for a deep learning (DL) model management system comprising interface circuitry, processor circuitry including one or more of at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations according to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations, or Application Specific Integrated Circuitry (ASIC) including logic gate circuitry to perform one or more third operations, the processor circuitry to perform at least one of the first operations, the second operations, or the third operations to instantiate difference determiner circuitry to analyze feature lists of models optimized for selected objectives to identify feature differences between a plurality of models, similarity determiner circuitry to analyze the plurality of feature lists of the plurality of models optimized for the plurality of selected objectives to identify feature similarities between the plurality of models, QoS selector circuitry to establish a QoS objective for prioritization of the plurality of selected objectives, and model scheduler circuitry to choose a model from the plurality of models for use on a target hardware platform.

Example 2 includes the apparatus of example 1, wherein the processor circuitry is to instantiate QoS sampler circuitry to sample a current state of the target hardware platform.

Example 3 includes the apparatus of example 1, wherein the QoS selector circuitry is to further sort the plurality of models based on an ability to maximize the QoS objective for prioritization.

Example 4 includes the apparatus of example 1, wherein the model scheduler circuitry is to further calculate model utilization metrics for the chosen model on the target hardware platform, and in response to determining that the model utilization metrics are below a threshold value, select another model of the plurality of models for use on the target hardware platform.

Example 5 includes the apparatus of example 1, wherein feature collector circuitry is to retain the plurality of features identified by the difference determiner circuitry and the similarity determiner circuitry.

Example 6 includes a method for deep learning (DL) model training, the method comprising extracting a plurality of models from a dataset, respective ones of the plurality of models optimized for a selected quality of service (QoS) objective of a plurality of QoS objectives, identifying a plurality of feature differences between respective ones of the plurality of models, and identifying a plurality of feature similarities between respective ones of the plurality of models.

Example 7 includes the method of example 6, wherein the plurality of feature differences and the plurality of feature similarities are aggregated for retention.

Example 8 includes a method for deep learning (DL) model management, the method comprising sampling a current state of a target hardware platform, selecting a quality of service (QoS) objective of a plurality of QoS objectives for prioritization based on the current state of the target hardware platform, sorting a plurality of models, respective ones of the plurality of models optimized for respective ones of the plurality of QoS objectives, selecting a model of the sorted plurality of models for use by the target hardware platform, calculating utilization metrics for the model on the target hardware platform, and in response to determining that the utilization metrics do not satisfy a threshold, selecting another model of the plurality of models for use by the target hardware platform.

Example 9 includes the method of example 8, wherein the sorting of the models is based on the selected QoS objective.

Example 10 includes a non-transitory computer readable medium comprising instructions that, when executed, cause a machine to at least analyze feature lists of models optimized for selected objectives to identify feature differences between a plurality of models, analyze the plurality of feature lists of the plurality of models optimized for the plurality of selected objectives to identify feature similarities between the plurality of models, establish a QoS objective for prioritization of the plurality of selected objectives, and choose a model from the plurality of models for use on a target hardware platform.

Example 11 includes the non-transitory computer readable medium of example 11, wherein a current state of the target hardware platform is sampled.

Example 12 includes the non-transitory computer readable medium of example 11, wherein the plurality of models are sorted based on an ability to maximize the QoS objective for prioritization.

Example 13 includes the non-transitory computer readable medium of example 11, wherein the instructions, when executed, further cause the machine to calculate model utilization metrics for the chosen model on the target hardware platform, and in response to determining that the model utilization metrics are below a threshold value, select another model of the plurality of models for use on the target hardware platform.

Example 14 includes the non-transitory computer readable medium of example 11, wherein the plurality of features identified by the difference determiner circuitry and the similarity determiner circuitry are retained.

Example 15 includes an apparatus comprising at least one interface circuit, instructions in the apparatus, and processor circuitry to execute the instructions to analyze feature lists of models optimized for selected objectives to identify feature differences between a plurality of models, analyze the plurality of feature lists of the plurality of models optimized for the plurality of selected objectives to identify feature similarities between the plurality of models, establish a QoS objective for prioritization of the plurality of selected objectives, and choose a model from the plurality of models for use on a target hardware platform.

Example 16 includes the apparatus of example 15, wherein the processor circuitry is to sample a current state of the target hardware platform.

Example 17 includes the apparatus of example 15, wherein the processor circuitry is to further sort the plurality of models based on an ability to maximize the QoS objective for prioritization.

Example 18 includes the apparatus of example 15, wherein the processor circuitry is to further calculate model utilization metrics for the chosen model on the target hardware platform, and in response to determining that the model utilization metrics are below a threshold value, select another model of the plurality of models for use on the target hardware platform.

Example 19 includes the apparatus of example 15, wherein processor circuitry is to retain the plurality of features identified by the difference determiner circuitry and the similarity determiner circuitry.

Example 20 includes the apparatus of example 18, wherein the threshold for model utilization metrics is a predetermined threshold.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus for a deep learning (DL) model management system comprising:
interface circuitry;
processor circuitry including one or more of:
at least one of a central processing unit, a graphic processing unit or a digital signal processor, the at least one of the central processing unit, the graphic processing unit or the digital signal processor having control circuitry to control data movement within the processor circuitry, arithmetic and logic circuitry to perform one or more first operations according to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations, or the third operations to instantiate:
difference determiner circuitry to analyze feature lists of models optimized for selected objectives to identify feature differences between a plurality of models;
similarity determiner circuitry to analyze the plurality of feature lists of the plurality of models optimized for the plurality of selected objectives to identify feature similarities between the plurality of models;
QoS selector circuitry to establish a QoS objective for prioritization of the plurality of selected objectives; and
model scheduler circuitry to choose a model from the plurality of models for use on a target hardware platform.

2. The apparatus of claim 1, wherein the processor circuitry is to instantiate QoS sampler circuitry to sample a current state of the target hardware platform.

3. The apparatus of claim 1, wherein the QoS selector circuitry is to further sort the plurality of models based on an ability to maximize the QoS objective for prioritization.

4. The apparatus of claim 1, wherein the model scheduler circuitry is to further:
calculate model utilization metrics for the chosen model on the target hardware platform; and
in response to determining that the model utilization metrics are below a threshold value, select another model of the plurality of models for use on the target hardware platform.

5. The apparatus of claim 1, wherein feature collector circuitry is to retain the plurality of features identified by the difference determiner circuitry and the similarity determiner circuitry.

6. A method for deep learning (DL) model management, the method comprising:
sampling a current state of a target hardware platform;
selecting a quality of service (QoS) objective of a plurality of QoS objectives for prioritization based on the current state of the target hardware platform;
sorting a plurality of models, respective ones of the plurality of models optimized for respective ones of the plurality of QoS objectives;
selecting a model of the sorted plurality of models for use by the target hardware platform;
calculating utilization metrics for the model on the target hardware platform; and
in response to determining that the utilization metrics do not satisfy a threshold, selecting another model of the plurality of models for use by the target hardware platform.

7. The method of claim 8, wherein the sorting of the models is based on the selected QoS objective.

8. A non-transitory computer readable medium comprising instructions that, when executed, cause a machine to at least:
analyze feature lists of models optimized for selected objectives to identify feature differences between a plurality of models;
analyze the plurality of feature lists of the plurality of models optimized for the plurality of selected objectives to identify feature similarities between the plurality of models;
establish a QoS objective for prioritization of the plurality of selected objectives; and
choose a model from the plurality of models for use on a target hardware platform.

9. The non-transitory computer readable medium of claim 11, wherein a current state of the target hardware platform is sampled.

10. The non-transitory computer readable medium of claim 11, wherein the plurality of models are sorted based on an ability to maximize the QoS objective for prioritization.

11. The non-transitory computer readable medium of claim 11, wherein the instructions, when executed, further cause the machine to:
calculate model utilization metrics for the chosen model on the target hardware platform; and
in response to determining that the model utilization metrics are below a threshold value, select another model of the plurality of models for use on the target hardware platform.

12. The non-transitory computer readable medium of claim 11, wherein the plurality of features identified by the difference determiner circuitry and the similarity determiner circuitry are retained.

13. An apparatus comprising:
at least one interface circuit;
instructions in the apparatus; and
processor circuitry to execute the instructions to:
analyze feature lists of models optimized for selected objectives to identify feature differences between a plurality of models;
analyze the plurality of feature lists of the plurality of models optimized for the plurality of selected objectives to identify feature similarities between the plurality of models;
establish a QoS objective for prioritization of the plurality of selected objectives; and
choose a model from the plurality of models for use on a target hardware platform.

14. The apparatus of claim 15, wherein the processor circuitry is to sample a current state of the target hardware platform.

15. The apparatus of claim 15, wherein the processor circuitry is to further sort the plurality of models based on an ability to maximize the QoS objective for prioritization.

16. The apparatus of claim 15, wherein the processor circuitry is to further:
calculate model utilization metrics for the chosen model on the target hardware platform; and
in response to determining that the model utilization metrics are below a threshold value, select another model of the plurality of models for use on the target hardware platform.

17. The apparatus of claim 15, wherein processor circuitry is to retain the plurality of features identified by the difference determiner circuitry and the similarity determiner circuitry.

18. The apparatus of claim 18, wherein the threshold for model utilization metrics is a predetermined threshold.
